(19) United States
(12) Patent Application Publication
(10) Pub. No.: US 2009/0010743 A1
(43) Pub. Date: Jan. 8, 2009

(54) Trailer adapted for use with a stone slinger

(76) Inventor: Wolfgang G. Wilz, West Jordan, UT (US)

Correspondence Address: THORPE NORTH & WESTERN, LLP., P.O. Box 1219, SANDY, UT, 84091-1219, US

(21) Appl. No.: 11/824,941

(22) Filed: Jul. 2, 2007

(51) Int. Cl. B65G 67/00

(52) U.S. Cl. 414/339; 414/502

(57) ABSTRACT

The present invention is drawn to a self unloading bottom discharge trailer. The trailer includes a coupler attached to the trailer adapted for attachment to a trailer hitch. The trailer also includes a hopper configured to carry an aggregate material and having a bottom discharge opening for unloading the aggregate material. A transfer conveyor belt system is disposed at least in part under the bottom discharge opening. The transfer conveyor belt is sized and shaped to receive bulk material from the bottom discharge opening and convey and elevate the material away from the bottom discharge opening. A throw conveyor belt is positioned adjacent the transfer conveyor belt system to receive bulk material from the transfer conveyor belt system. The throw conveyor belt is operable at varying speeds to throw the bulk material variable distances into the hopper of an adjacent bulk material transport vehicle.

### BACKGROUND OF THE INVENTION

Dump trucks often carry particulate aggregate material such as sand, gravel, dirt, grain, and the like. Dump trucks usually have a large rectangular bin, or hopper, pivotally coupled to the chassis or frame of the dump truck. The forward end of the hopper can be raised to tip the hopper and discharge, or dump the contents of the hopper out of the rear tailgate of the hopper. Unloading the contents of the hopper in this manner is usually a quick way to empty the contents of the hopper. Unloading the entire load of the dump truck in this way is not always desirable because it deposits the load of the dump truck in only one location at the back of the truck. Additionally, dump trucks are often unable to deposit their loads exactly where they are needed because of obstacles between the roadway and the desired dump site. In these cases, the load must often be manually moved from the dump location to where it is needed.

To solve this problem, special conveyors called “stone slingers” have been coupled to hoppers of dump trucks. A stone slinger includes a conveyor that can be attached to receive the aggregate material from the hopper and convey the material to a location that is remote from the dump truck. FIG. 1 (Prior Art) shows the stone slinger dump truck 10 with the hopper 12 in an level configuration and the stone slinger 14 conveniently stowed in a transport position along side the hopper. Such stone slingers can be moved or pivoted about the back of the vehicle as desired during discharge of the aggregate material in order to place and spread the material at different locations away from the truck. In this way, the aggregate material can be delivered directly to where it is needed.

While these stone slingers work well at delivering the aggregate material from the hopper of the truck, they also have limitations. For example, it will be appreciated that a stone slinger can only move material from a hopper to which it is attached. Thus, for jobs that require more material than can be carried by a single hopper, multiple trucks or trips are required, costing expense and/or time to the user or contracting party.

### SUMMARY OF THE INVENTION

The present invention provides for a self unloading discharge trailer. The trailer can include a coupler attached to the trailer adapted for attachment to a trailer hitch. The trailer can also include a hopper configured to carry an aggregate material and having a bottom discharge opening for unloading the aggregate material. A transfer conveyor belt system can be disposed at least in part under the discharge opening. The transfer conveyor belt can be sized and shaped to receive bulk material from the discharge opening and convey and elevate the material away from the discharge opening. A throw conveyor belt can be positioned adjacent the transfer conveyor belt system to receive bulk material from the transfer conveyor belt system. The throw conveyor belt can be operable at varying speeds to throw the bulk material variable distances into the hopper of an adjacent bulk material transport vehicle.

In another aspect, the present invention provides for an aggregate material transport device including a first hopper having a discharge opening and a stone slinger coupled to the discharge opening. The stone slinger can be configured to receive material from the hopper for delivery to a dump site remote from the hopper. The stone slinger can also include a frame pivotally associated with the first hopper and positioned adjacent the discharge opening. A conveyor belt can be movably disposed on the frame. A second hopper having a discharge opening can be adapted for being pulled as a trailer behind the first hopper. A transfer conveyor can be disposed under the discharge opening of the second hopper. The transfer conveyor can extend to an upper transfer point adjacent the first hopper. The transfer conveyor can transfer material from the second hopper to the first hopper. The present invention also includes a method for unloading aggregate material from a double trailer dump truck including engaging a discharge opening in a first hopper coupled to the dump truck to release aggregate material from the first hopper. A stone slinger can be engaged to receive and propel aggregate material from the first hopper to a remote dump site. The stone slinger can include an frame pivotally connected to the hopper adjacent the discharge opening and an endless conveyor belt movable on the frame. The endless belt can be movable at a sufficiently rapid rate so as to propel aggregate material away from the hopper to the remote dump site. A second hopper coupled to a double trailer can be positioned adjacent the first hopper. A discharge opening in the second hopper can be opened to release aggregate material from the second hopper, and a conveyor can be engaged to receive and move aggregate material from the second hopper to the first hopper.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a side view of a truck with a stone slinger in an extended position in accordance with a prior art embodiment;

FIG. 2 is a side view of a self unloading bottom discharge trailer in accordance with an embodiment of the present invention for use in transporting aggregate material and having a throw conveyor extended in an operable position;

FIG. 3 is a side view of the self unloading bottom discharge trailer of FIG. 3, shown with the throw conveyor in a stowed position;

FIG. 4 is a side view of an aggregate material transport device in accordance with another embodiment of the present invention, shown with a throw conveyor on a self unloading bottom discharge trailer extended in an operable position;

FIG. 5 is a side view of the aggregate material transport device of FIG. 5, shown with the throw conveyor in a stowed position;

FIG. 6 is a side view of an aggregate material transport device in accordance with another embodiment of the present invention, shown with a throw conveyor on a self unloading bottom discharge trailer extended in an operable position; and

FIG. 7 is a side view of the aggregate material transport device of FIG. 7, shown with the throw conveyor in a stowed position.

### DETAILED DESCRIPTION OF THE PREFERRED EMBODIMENT(S)

Before the present invention is disclosed and described, it is to be understood that this invention is not limited to the particular process steps and materials disclosed herein because such process steps and materials may vary somewhat. It is also to be understood that the terminology used herein is used for the purpose of describing particular embodiments only. The terms are not intended to be limiting because the scope of the present invention is intended to be limited only by the appended claims and equivalents thereof.

It is noted that, as used in this specification and the appended claims, the singular forms “a,” “an,” and “the” include plural referents unless the context clearly dictates otherwise.

As used herein, the terms “transport device” refers to any vehicle, powered or un-powered, with a hopper type aggregate material container. For example, a transport device can be a dump truck, a dump trailer, a hopper truck, a hopper trailer, a hopper railcar, a transfer trailer, and the like.

As used herein, “stone slinger” refers to a conveyor system configured to receive aggregate material, such as sand, gravel, soil, grain, and the like, from a hopper on a transport vehicle and convey and distribute the aggregate material to a dump site remote from the transport vehicle.

As used herein, “plurality” refers to more than one. For example, a plurality of transport devices refers to at least two transport devices.

As used herein, a plurality of components may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

With these definitions in mind, it has been recognized that it would be advantageous to develop a method and device for moving aggregate material from a trailer hopper to a stone slinger truck hopper so that the stone slinger can convey the material to a remote dump site. It has also been recognized that it would be advantageous to develop an aggregate material transport system including a set of double or triple trailers with a device that can move aggregate material from one trailer to a stone slinger trailer or truck that can convey the material to a remote dump site.

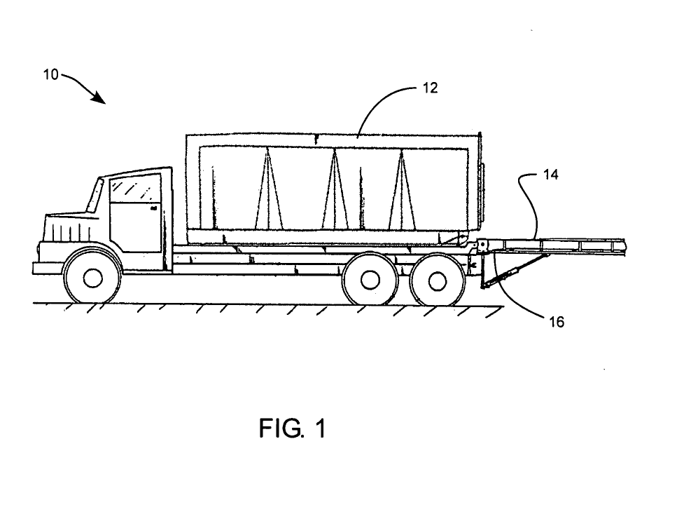

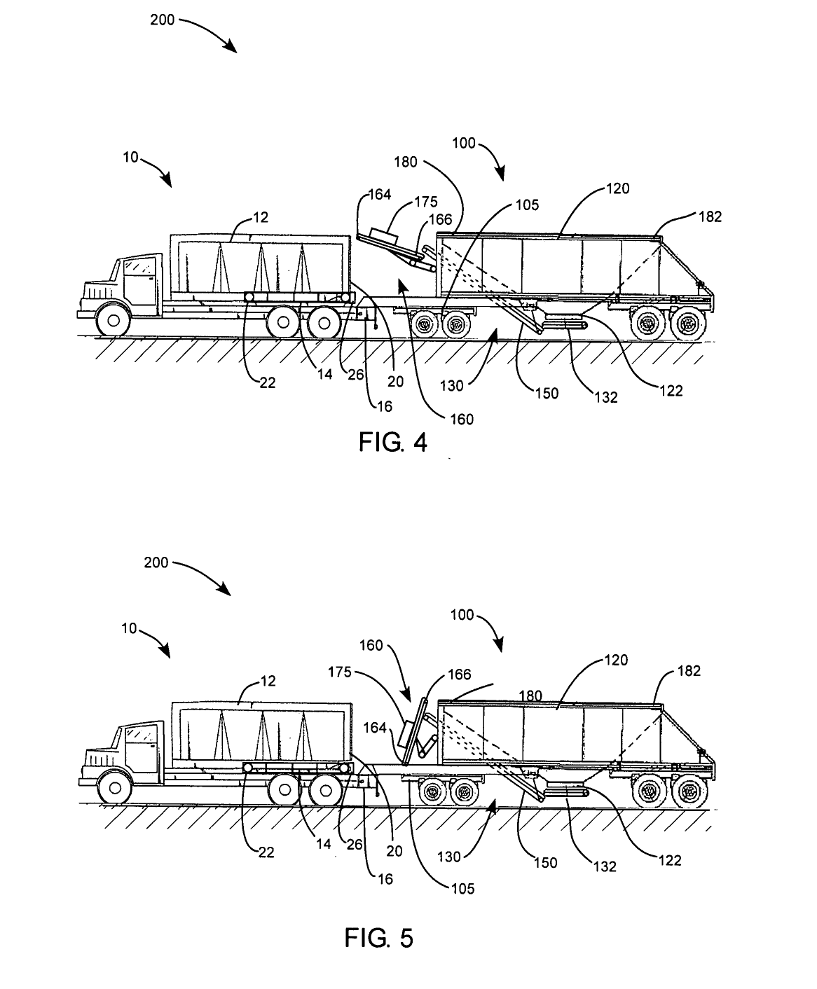

As illustrated in FIGS. 3-4, a self unloading bottom discharge trailer, indicated generally at 100, is shown in accordance with an embodiment of the present invention for use in transporting aggregate material by being towed behind a motorized transport vehicle, such as a dump truck 10 (FIG. 1), or stone slinger truck. The trailer can have a coupler 110 for attaching the trailer to a motorized vehicle, a hopper 120 for carrying aggregate material, a transfer conveyor, indicated generally at 130, and a throw conveyor, indicated generally at 160.

Additionally, as known by those skilled in the art, the trailer can be a single axle trailer, a double axle trailer 100, or a triple axle trailer as needed in order to distribute the weight of the loaded trailer on a roadway. Moreover, the trailer can have a converter dolly 105 as necessary to further distribute the weight of the trailer on a roadway.

The coupler 110 can be attached to the trailer and can be adapted to attach the trailer to a mating trailer hitch 16 on another trailer or motorized vehicle 10 (FIG. 1). In this way, the coupler can be configured to attach the trailer in double to another trailer or transport. Thus, the coupler can be any suitable trailer towing device as known by those skilled in the art. For example, the coupler can be a standard semi truck and tractor trailer hitch, a standard fifth wheel trailer hitch, or the like.

The hopper 120 can be sized and shaped to carry an aggregate material such as rock, sand, gravel, soil, grain, or the like. In one aspect, the hopper can have a bottom discharge opening 122 for discharging the aggregate material from the hopper. In another aspect, the hopper can be a dump style hopper (not shown) that can tilt to dump the material to a position behind the hopper.

The transfer conveyor can be a conveyor belt system, indicated generally at 130, disposed at least in part under the bottom discharge opening 122 of the trailer 100. The transfer conveyor can include at least one conveyor belt 132 that can be sized and shaped to receive bulk material from the bottom discharge opening. The transfer conveyor can then convey and elevate the material away from the bottom discharge opening.

In one aspect, the transfer conveyor belt system 130 can include a first conveyor belt 132 and a second conveyor belt 134. The first and second conveyor belts may each include a continuous belt 140, and a drive wheel 142, a tension wheel 144, and at least one idler wheel (not shown). The wheels 142, 144 can be disposed inside the continuous belts such that the drive wheel turns the continuous belt around the tension wheel and the idler wheels. Additionally, at lease one motor 148 can be operably coupled to the transfer conveyor belt system and the throw conveyor belt. The motor can hydraulically, electrically, or mechanically turn the drive the continuous belts.

The first conveyor belt 132 can be a substantially horizontal conveyor belt directly under the discharge opening 122. The first conveyor belt can extend along the discharge opening in a substantially parallel orientation with respect to a longitudinal axis of the hopper 120 of the trailer 100.

The second conveyor belt 134 can be inclined with respect to the first conveyor belt 132. The second conveyor belt can be positioned adjacent a discharge end 136 of the first conveyor belt and can extend at an incline to a distal end 138 adjacent the throw conveyor belt 160. The distal end can be positioned at a higher elevation than the discharge end of the first belt. Advantageously, the incline of the second conveyor belt can be angularly adjustable with respect to the first conveyor belt so as to be able to position the distal end of second conveyor at a desired height relative to the throw conveyor 160 and the hopper 12 of an adjacent transport vehicle 10 (FIG. 1).

In this way, the first conveyor belt 132 can receive material discharged from the hopper 120 and can convey the material to the second conveyor belt 134. The second, inclined conveyor belt can receive the material from the first, horizontal conveyor belt and can elevate the material to the adjacent throw conveyor 160.

The throw conveyor 160 can include a conveyor belt 162 that can be positioned adjacent the transfer conveyor belt system 130. The throw conveyor belt can receive bulk material from the transfer conveyor belt system and can throw the material away from the trailer 100 to a remote discharge location. In one aspect, the throw conveyor belt 162 can be operable at varying speeds in order to throw the bulk material variable distances into the hopper 12 of an adjacent bulk material transport vehicle 10 (FIG. 1).

The throw conveyor belt 162 can be positionable between an operable position, as shown in FIG. 3, and a stowed position, as shown in FIG. 4. In the operable position the throw conveyor belt can extend from a discharge end, or the distal end 138, of the transfer conveyor belt system 130 to a remote position away from the hopper 120. In the stowed position, the throw conveyor belt can be positioned adjacent the hopper such that the trailer can be transported along a roadway.

It is noted that the shown “stowed” position and “operable” position are merely exemplary, as they can be in other positions when stowed or operable. For example, the stowed position can be more compactly folded against the hopper, or the operable position can be more extended that is shown in the FIGS. In one embodiment, the operable position can be such that the throw conveyor is substantially horizontal rather than angled as shown. In another embodiment, the stowed position can be over the top of the hopper 120.

The throw conveyor 160 can also include flow directors 170 to direct the flow of material being thrown from the throw conveyor. In one aspect, the flow directors can include a spreader 172 attached to the discharge end 164 of the throw conveyor belt 162. The spreader can spread the aggregate material discharged from the throw conveyor belt. Additionally, the throw conveyor belt can be removable from the trailer 100.

The throw conveyor 160 can also include an aggregate material flow control device 175. The flow control device can contain aggregate material on the throw conveyor as it is propelled at relatively high rates of flow along the conveyor. Additionally, the flow control device can aid in directing the flow of material by creating a wind row along the throw conveyor. The wind row can keep the aggregate material on the throw conveyor. For example, in one embodiment, the aggregate material flow control device can be a Supershield™.

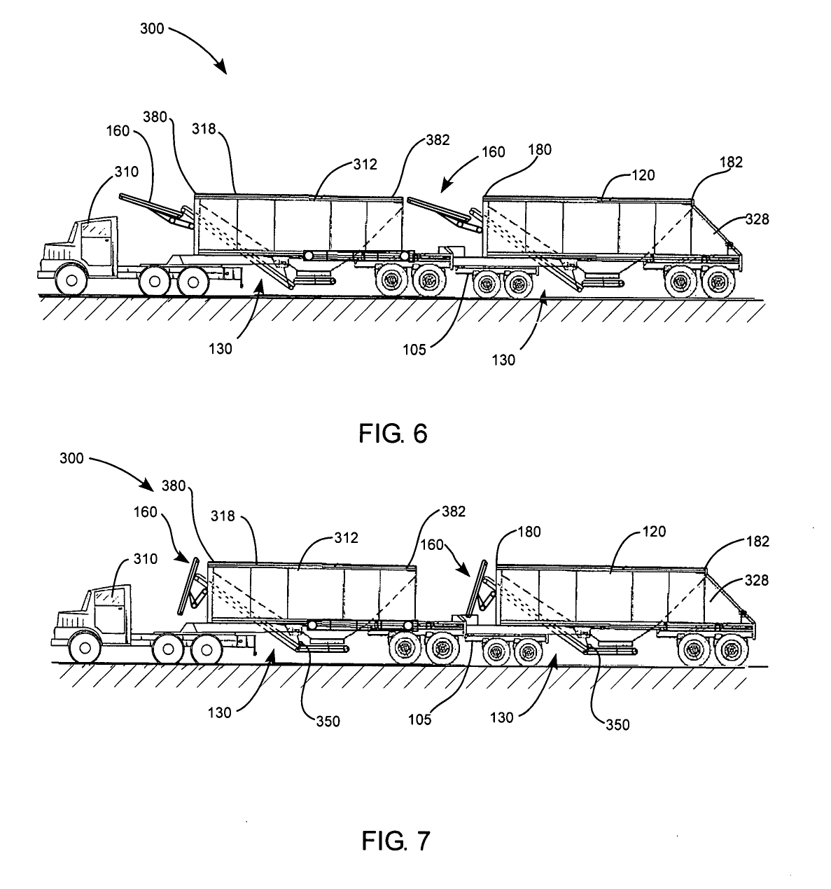

As illustrated in FIGS. 5-6, an aggregate material transport device, indicated generally at 200 is shown in accordance with another embodiment of the present invention for use in transporting aggregate material. The aggregate material transport device can include a first hopper 12 coupled to a motorized vehicle 10 and a stone slinger 14 that can receive and deliver material discharged from the first hopper. Additionally, the aggregate material transport device can include a self unloading bottom discharge trailer 100 described above and shown in FIGS. 3-4.

In a more detailed aspect, the first hopper 12 can have a rear discharge opening 20 and the stone slinger 14 can be coupled to the transport device 10 adjacent to the discharge opening. The stone slinger can receive material from the discharge opening of the first hopper and can deliver the material to a dump site remote from the first hopper.

The stone slinger 14 can also include a frame 22 pivotally associated with the first hopper 12 or the converter dolly 105 and pivotable adjacent the discharge opening 20. A conveyor belt 24 can be disposed about the frame and can move on the frame at a sufficiently rapid rate so as to propel aggregate material away from the first hopper, dump body, or stone slinger to the remote dump site.

The stone slinger 14 can also include a swing arm 26 operably coupled to the first hopper 12 and the frame 22. The swing arm can operate to swing the frame to an angular position with respect to a longitudinal axis of the first hopper. A motor (not shown) can be operably coupled to the swing arm, and can operate to position the frame in a desired angular position. In this way the stone slinger can be pivoted or turned so as to discharge the aggregate material from the first hopper in various locations in order to spread the material around a work site.

As discussed above, the second hopper 120 can be coupled to a trailer similar to the self unloading bottom discharge trailer 100 described above and shown in FIGS. 3-4. Accordingly the second hopper can have a discharge opening 122, and can be adapted for being pulled as a trailer behind the first hopper 12. Additionally, the trailer can include a transfer conveyor 130 disposed under the discharge opening of the second hopper. The transfer conveyor can extend to an upper transfer point adjacent the first hopper, and can transfer material from the second hopper to the first hopper.

In one aspect, the transfer conveyor 130 can include a throw conveyor 160 having a proximal end 164 disposed adjacent the upper transfer point of the transfer conveyor and a distal end 166 positionable adjacent the first hopper 12. The transfer conveyor can also have a frame 150 with an endless conveyor belt 140 movable on the frame. The endless conveyor belt can be movable at a sufficiently rapid rate so as to propel aggregate material into the first hopper.

As illustrated in FIGS. 6-7, an aggregate material transport device, indicated generally at 300 is shown in accordance with another embodiment of the present invention for use in transporting aggregate material. The aggregate material transport device can include a first hopper 312 coupled to a trailer 318 removably coupled to a motorized vehicle 310. The first hopper can also include a stone slinger 314 that can receive and deliver material discharged from the first hopper.

Additionally, the aggregate material transport device 300 can include a second hopper 320 coupled to a second trailer 328. The second trailer can be coupled to the first trailer 318. The second trailer can be similar to the self unloading bottom discharge trailer 100 described above and shown in FIGS. 3-4. Accordingly, the second trailer can have a transport conveyor 130 and a throw conveyor 160 that can move aggregate material from the second hopper to the first hopper so that the stone slinger attached to the first hopper can deliver the material to a remote dump site.

The present invention also includes a method for unloading aggregate material from a truck and trailer including engaging a discharge opening in a first hopper coupled to the truck to release aggregate material from the first hopper. A stone slinger can be engaged to receive and propel aggregate material from the first hopper to a remote dump site. The stone slinger can include a frame pivotally connected to the hopper adjacent the discharge opening and an endless conveyor belt movable on the frame. The endless belt can be movable at a sufficiently rapid rate so as to propel aggregate material away from the hopper to the remote dump site. A trailer with a second hopper can be positioned adjacent the first hopper. A discharge opening in the second hopper can be opened to release aggregate material from the second hopper, and a conveyor can be engaged to receive and move aggregate material from the second hopper to the first hopper.

The method can also include engaging a conveyor belt disposed adjacent the discharge opening of the second hopper to receive and move aggregate material from the second hopper to a throw conveyor belt. The throw conveyor belt can be engaged to receive and propel aggregate material from the conveyor belt into the first hopper.

Additionally, the step of engaging a conveyor can transfer material from the second hopper to the first hopper. In this way the first hopper can be refilled by the contents of the second hopper after the stone slinger empties the aggregate material in the first hopper.

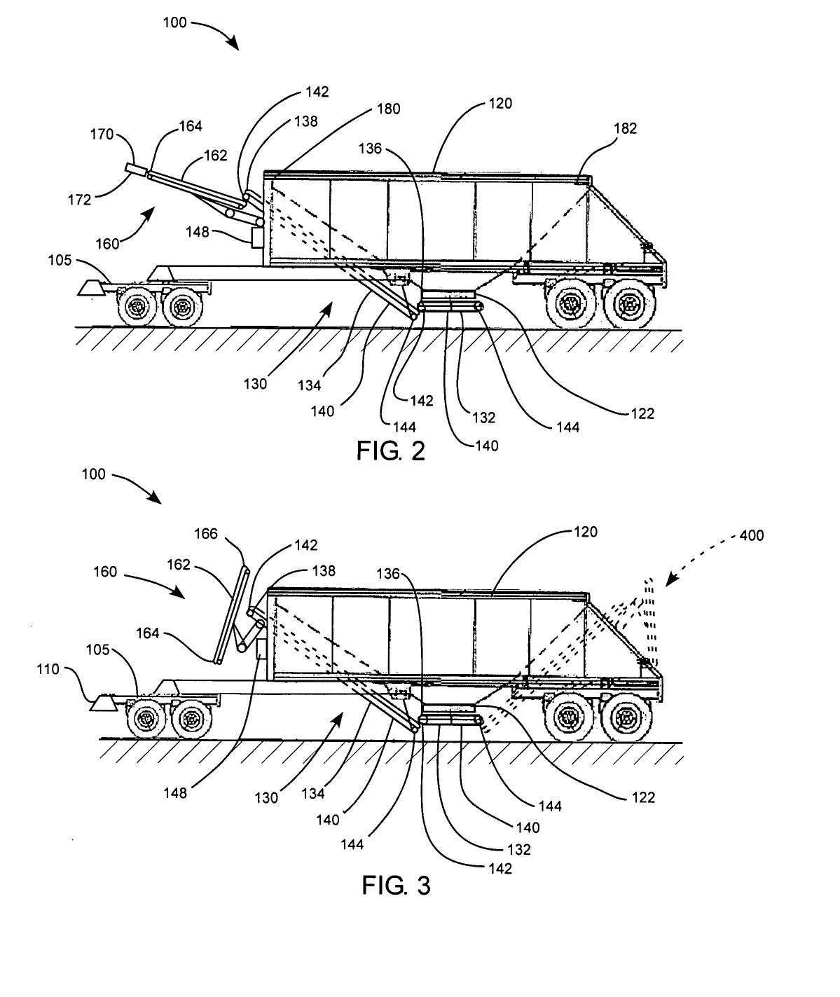

Although the embodiments described herein and shown in FIGS. 2-8 illustrate an aggregate material transport device 100 and 300 with a transfer conveyor belt system 130 and throw conveyor belt 160 operably coupled to the front end 180 or 380 of the transport device, it will be appreciated that the transfer conveyor belt system and throw conveyor belt can also be positioned near the rear or back end 182 or 382 of the transport device, as shown generally as dashed lines at 400 in FIG. 3. Additionally, although FIGS. 2-6 show a two conveyor belt system, it will be appreciated that the transfer conveyor belt system 130 can be a single conveyor belt, as shown in FIG. 7. In the case where the transfer conveyor belt system is a single conveyor belt it will be apparent that the belt can have an idler wheel 350 that can form joint or elbow in the conveyor belt, as known in the art, such that a portion of the conveyor belt can convey material from the discharge opening 122 to an elevated portion of the conveyor belt that can move material from the hopper 120 to a remote and elevated location away from the hopper.

While the invention has been described with reference to certain preferred embodiments, those skilled in the art will appreciate that various modifications, changes, omissions, and substitutions can be made without departing from the spirit of the invention. It is intended, therefore, that the invention be limited only by the scope of the following claims.

What is claimed is:

1. A self unloading bottom discharge trailer, comprising:
a coupler attached to the trailer adapted for attachment to a trailer hitch;
a hopper configured to carry an aggregate material and having a bottom discharge opening for unloading the aggregate material;
a transfer conveyor belt system disposed at least in part under the bottom discharge opening, said transfer conveyor belt sized and shaped to receive bulk material from the bottom discharge opening and convey and elevate the material away from the bottom discharge opening; and
a throw conveyor belt positioned adjacent the transfer conveyor belt system to receive bulk material from the transfer conveyor belt system, said throw conveyor belt operable at varying speeds to throw the bulk material variable distances into the hopper of an adjacent bulk material transport vehicle.

2. The trailer of claim 1, wherein the coupler is configured to attach the trailer to another trailer to form a set of trailers.

3. The trailer of claim 1, further comprising at lease one motor operably coupled to the transfer conveyor belt system and the throw conveyor belt and operable to drive the belts.

4. The trailer of claim 1, the transfer conveyor belt system further comprising:
a first conveyor belt disposed under the hopper and parallel to a longitudinal axis of the hopper; and
a second conveyor belt disposed adjacent a discharge end of the first belt and extending at an incline with respect to the first conveyor belt to a distal end adjacent the throw conveyor belt at a higher elevation than the discharge end of the first belt.

5. The trailer of claim 4, wherein the second conveyor belt is angularly adjustable with respect to the first conveyor belt.

6. The trailer of claim 4, wherein the first and second conveyor belts each include a continuous belt, and a drive wheel, a tension wheel, and at least one idler wheel, associated with the continuous belt such that the drive wheel turns the continuous belt around the tension wheel and the idler wheels.

7. The trailer of claim 1, wherein the throw conveyor belt is positionable between an operable position with the throw conveyor belt extending from a discharge end of the transfer conveyor belt system to a remote position away from the hopper, and a stowed position with the throw conveyor belt positioned adjacent the hopper.

8. The trailer of claim 1, wherein the throw conveyor belt includes flow directors to direct the flow of material being thrown from the throw conveyor.

9. The trailer of claim 1, wherein the throw conveyor belt has a discharge end with a spreader to spread the aggregate material discharged from the throw conveyor belt.

10. The trailer of claim 1, wherein the throw conveyor belt is removable from the trailer.

11. The trailer of claim 1, wherein the throw conveyor belt is operably connected to the transfer conveyor belt system with a lower hydraulic arm that positions the throw conveyor belt in an operable position or a storage position.

12. The trailer of claim 1, wherein the throw conveyor belt is angularly adjustable with respect to the transfer conveyer belt system.

13. The trailer of claim 1, wherein the adjacent bulk material transport vehicle is selected from the group consisting of a stone slinger vehicle, a dump truck, or combinations thereof.

14. The trailer of claim 1, wherein the transfer conveyor belt system and the throw conveyor belt are positioned adjacent a front end or back end of the trailer.

15. The trailer of claim 1, wherein the throw conveyor belt further includes a flow control device to contain and direct the flow of aggregate material on the throw conveyor.

16. An aggregate material transport device, comprising:
a first hopper having a discharge opening;
a stone slinger coupled to the discharge opening and configured to receive material from the hopper for delivery to a dump site remote from the hopper, the stone slinger further comprising:
i) a frame pivotally associated with the hopper adjacent the discharge opening; and
ii) a conveyor belt movable on the frame, and movable at a sufficiently rapid rate so as to propel aggregate material away from the hopper to the remote dump site;
a second hopper having a discharge opening, said second hopper adapted for being pulled as a trailer behind the first hopper; and
a transfer conveyor disposed under the discharge opening of the second hopper, extending to an upper transfer point adjacent the first hopper, and configured to transfer material from the second hopper to the first hopper.

17. The device of claim 16, further comprising a throw conveyor having a proximal end disposed adjacent the upper transfer point of the transfer conveyor and a distal end positionable adjacent the first hopper, said throw conveyor including a frame with an endless conveyor belt movable on the frame and movable at a sufficiently rapid rate so as to propel aggregate material into the first hopper.

18. The device of claim 16, wherein the throw conveyor belt is operable at varying speeds to throw the bulk material from the second hopper variable distances into the first hopper.

19. The device of claim 16, wherein the stone slinger further comprises:
a swing arm operably coupled to the first hopper and the frame, and operable to swing the frame to an angular position with respect to a longitudinal axis of the first hopper; and
a motor operably coupled to the swing arm, and operable to position the frame in a desired angular position.

20. The device of claim 16, wherein the first hopper is attached to a frame of a motorized vehicle and the second hopper is a trailer removably coupleable to the frame of the motorized vehicle.

21. The device of claim 16, wherein the first hopper includes a trailer removably coupleable to a motorized vehicle and the second hopper includes a trailer removably coupleable to the first hopper trailer.

22. The device of claim 16, wherein the transfer conveyor includes a conveyor belt system, further comprising:
a first conveyor belt disposed the discharge opening of the second hopper and parallel to a longitudinal axis of the second hopper; and
a second conveyor belt disposed adjacent a discharge end of the first conveyor belt and extending to an elevated distal end.

23. The device of claim 22, further comprising a throw conveyor having a proximal end disposed adjacent the elevated distal end of the second conveyor belt and a distal end positionable adjacent the first hopper.

24. The device of claim 1, wherein the transfer conveyor belt system and the throw conveyor belt are positioned adjacent a front end or back end of the trailer.

25. The trailer of claim 1, wherein the throw conveyor belt further includes a flow control device to contain and direct the flow of aggregate material on the throw conveyor.

26. A method for unloading aggregate material from a trailer, comprising:
engaging a discharge opening in a first hopper coupled to the truck to release aggregate material from the first hopper;
engaging a stone slinger to receive and propel aggregate material from the first hopper to a remote dump site, the stone slinger including
i) a frame pivotally connected to the hopper adjacent the discharge opening,
ii) an endless conveyor belt movable on the frame, and
iii) being movable at a sufficiently rapid rate so as to propel aggregate material away from the hopper to the remote dump site;
positioning a second hopper coupled to a trailer adjacent the first hopper;
opening a discharge opening in the second hopper to release aggregate material from the second hopper; and
engaging a conveyor to receive and move aggregate material from the second hopper to the first hopper.

27. The method of claim 26, wherein the step of engaging the conveyor further comprises:
engaging a conveyor belt disposed adjacent the discharge opening of the second hopper to receive and move aggregate material from the second hopper to a throw conveyor belt; and
engaging the throw conveyor belt to receive and propel aggregate material from the conveyor belt into the first hopper.

28. The method of claim 26, wherein the step of engaging the conveyor transfers material from the second hopper to the first hopper to refill the first hopper after the stone slinger at least substantially empties or is in the process of emptying the aggregate material from the first hopper.
